(19) United States
(12) Patent Application Publication
(10) Pub. No.: US 2017/0251296 A1
(43) Pub. Date: Aug. 31, 2017

(54) LOUDSPEAKER WITH NARROW DISPERSION

(71) Applicant: Dolby Laboratories Licensing Corporation, San Francisco, CA (US)

(72) Inventor: Michael SMITHERS, Kareela (AU)

(73) Assignee: Dolby Laboratories Licensing Corporation, San Francisco, CA (US)

(21) Appl. No.: 15/512,816

(22) PCT Filed: Sep. 17, 2015
(86) PCT No.: PCT/US2015/050730

§ 371 Date: Mar. 20, 2017

Related U.S. Application Data
(60) Provisional application No. 62/052,596, filed on Sep. 19, 2014.
(60) Provisional application No. 62/182,042, filed on Jun. 19, 2015.

(51) Int. Cl. H04R 1/24; H04R 3/14; H04R 1/30; H04R 1/40

(52) U.S. Cl. CPC H04R 1/24; H04R 1/403; H04R 3/14; H04R 1/30; H04R 2201/403

(57) ABSTRACT

A column loudspeaker with a line of low-frequency drivers has a center coaxial driver with a low frequency driver and a high frequency drive. The low frequency drivers are delayed and gain adjusted such that they exhibit constant directivity in the axis of the line. The high frequency driver has the same directivity as the line of low frequency drivers. A crossover separates the audio signal into high and low frequency signals with low frequency signals sent to the low frequency drivers, and high frequency signals sent to the high frequency element in the coaxial driver. The crossover frequency is in the frequency range where the directivity of the high and low frequency drivers match. The loudspeaker cabinet is curved to provide an acoustic delay to the drivers further away from the center coaxial driver.

### CROSS REFERENCE TO RELATED APPLICATIONS

This application claims priority to U.S. Provisional Patent Application No. 62/052,596 filed on 19 Sep. 2014 and U.S. Provisional Patent Application No. 62/182,042 filed on 19 Jun. 2015, both hereby incorporated in their entirety by reference.

### FIELD OF THE INVENTION

One or more implementations relate generally to audio speakers, and more specifically to column loudspeakers with drivers that provide narrow dispersion.

### BACKGROUND

The sound projection pattern of a speaker is referred to as dispersion. Most speakers and speaker systems tend to exhibit or feature some degree of directivity or focus due to design and application constraints. Moreover, dispersion changes with frequency such that the bigger the speaker driver, the narrower its dispersion at higher frequencies. Many approaches have been adopted to improve or tailor the projection patterns of speakers, such as the use of different types/sizes of drivers, speaker baffling, and circuitry such as crossovers and delays.

While many of these approaches seek to improve speaker dispersion, narrow sound dispersion or high directivity, typically in the vertical axis, is often beneficial in many applications such as live sound reinforcement and cinema sound. Various different solutions can be used to produce narrow dispersion. For example, line or column loudspeakers use multiple loudspeaker drivers, mounted in a line, to achieve narrower sound dispersion in the axis of the line of the loudspeaker drivers. For a simple straight line of loudspeaker drivers, with each driver receiving the same electrical signal and radiating approximately the same sound energy or level, the sound dispersion or directivity of the line of loudspeaker drivers varies with frequency. At very low frequencies, the directivity is low and the sound dispersion characteristic is wide, often omnidirectional. With increasing frequency, the directivity increases. Also the sound dispersion pattern, the axis of the line of the loudspeaker, becomes more complex with nulls and lobes of sound radiating in directions other than the forward direction of the loudspeaker column. These lobes are called side-lobes. Side-lobes generally represent unwanted radiation in undesired directions, and excessive side-lobe radiation waste.

A number of techniques can be used to make the directivity more consistent (vary less) with frequency and thus reduce the amount and level of side-lobe radiation. These techniques include adding curvature to the loudspeaker line (by physical design), electrically delaying the audio signal independently to each loudspeaker driver, having unequal or random spacing between the loudspeaker drivers, applying electrical phase shifts independently to each driver, applying different gains to each driver, or other similar techniques.

One known approach applies specific driver delays, through either array curvature or electrical delay methods, used in conjunction with specific varying of signal level to each driver to provide constant directivity over a wide frequency range and with little to no side-lobes. In this approach, the directivity is approximately constant from a low frequency whose wavelength is approximately half the length of the line of drivers up to a high frequency whose wavelength is approximately the same as the center-to-center driver spacing. Below the lower frequency, some directivity is still present but the sound dispersion pattern tends to omnidirectional at frequencies with wavelengths longer than twice the length of the line of loudspeaker drivers.

Whilst many sufficiently small loudspeaker drivers, closely spaced, can cover a very wide frequency range with constant directivity, the maximum sound output is generally too low for many applications. A 2-way configuration increases output by having a line of larger, lower frequency drivers immediately adjacent to a line of smaller, higher frequency drivers and an electrical or digital crossover with a split frequency chosen where both lines have a constant directivity characteristic. However, such a 2-way loudspeaker configuration presents two challenges. First, it requires a very large number of loudspeaker drivers and associated wiring, particularly for the high frequencies; and second, depending on the choice of crossover filter, the dispersion pattern of the loudspeaker may have nulls and lobbing in the axis perpendicular to the line of the drivers.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF EMBODIMENTS

Embodiments are described for a speaker a loudspeaker having a plurality of drivers arranged in a linear arrangement along a first axis, a center coaxial driver disposed in a center position of the linear arrangement and having a low frequency driver and a high frequency driver, a gain stage associated with each driver of the plurality of drivers and the center driver; and a crossover configured to transmit low-frequency audio to the plurality of drivers and the low-frequency driver of the center coaxial driver and to transmit high frequency audio to the high-frequency driver of the center coaxial driver. The loudspeaker further comprises a speaker cabinet enclosing the plurality of drivers and the center driver, and which has a curvature prescribing an arc of approximately 60 degrees to provide an acoustic delay relative to the center coaxial driver to drivers disposed closer to the end of the linear arrangement. The low frequency driver of the center coaxial driver is configured to have matching characteristics to the plurality of drivers, and which comprise maximum sound pressure level and frequency response shape. The plurality of drivers is delayed and gain adjusted such that the linear arrangement of drivers exhibits constant directivity along the first axis. The low-frequency driver of the center coaxial driver passes audio signals in a first frequency range, and the high-frequency driver of the center coaxial driver passes audio signals in a second, higher frequency range, and the first and second frequency ranges are defined by a crossover frequency. The crossover frequency is selected to match the frequency range where the directivity of the high frequency driver and low frequency driver overlap. The high frequency driver of the center coaxial speaker comprises one of a symmetrical horn transducer or an asymmetrical horn transducer. In an embodiment, the center coaxial speaker may itself comprise a horn transducer. For this embodiment there may be one or more cone drivers disposed in one or more walls of the horn transducer. The one or more walls may also include a plurality of slots, and the one or more cone drivers may be configured to radiate sound through the plurality of slots. In an embodiment, the low frequency drivers comprise five-inch cone drivers and the first frequency range comprises 70 Hz to 2 kHz, and wherein the second frequency range comprises an audible frequency range above 2 kHz.

Embodiments are further directed to a column loudspeaker comprising a line of low frequency drivers arranged around a center coaxial driver having a low frequency driver and a high frequency driver, wherein the low frequency drivers are delayed and gain adjusted to thereby exhibit constant directivity along the line, and wherein the high frequency driver has the same directivity as the line of low frequency drivers; a crossover configured to separate an input audio signal into high and low frequency signals, wherein the low frequency signals are sent to the low frequency drivers, and high frequency signals sent to the high frequency driver; and a curved loudspeaker cabinet enclosing the low frequency drivers and the center coaxial driver. The cabinet may be configured to have a curvature prescribing an arc of approximately 60 degrees to provide a proportionate acoustic delay relative to the center coaxial driver to drivers disposed increasingly further away from the center coaxial driver. The low frequency driver of the center coaxial driver may be configured to have matching characteristics to the line of low frequency drivers, and the matching characteristics may be maximum sound pressure level and frequency response shape. In an embodiment, the low-frequency driver of the center coaxial driver passes audio signals in a first frequency range, and the high-frequency driver of the center coaxial driver passes audio signals in a second, higher frequency range, and the first and second frequency ranges are defined by a crossover frequency. The crossover frequency may be selected to match the frequency range where the directivity of the high frequency driver and low frequency driver overlap.

Embodiments are yet further directed to methods of making and using or deploying the speakers, transducers, and other component designs that provide a line array or column loudspeaker with narrow dispersion.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a column loudspeaker with a coaxial center driver to provide narrow dispersion, under some embodiments.

FIG. 2 illustrates a curved speaker cabinet at a prescribed arc angle and housing a line array of drivers under an embodiment.

FIG. 3 illustrates a coaxial driver that may be used in the loudspeaker of FIG. 1, under an embodiment.

FIG. 4 is a schematic diagram of the speaker system of FIG. 1, under an embodiment.

FIG. 5 is a table that lists example gain values for speakers in an array, under an embodiment.

FIG. 6 is a frequency response curve of a crossover that may be used in the speaker circuit of FIG. 4, under an embodiment.

FIG. 7 illustrates simulated vertical polar responses at various frequencies for example loudspeakers drivers with a coaxial driver, under an embodiment.

FIG. 8 shows measured vertical polar responses for the example loudspeaker at the same frequencies as in FIG. 7 and measured at a distance of approximately 4.3 meters.

FIG. 9 shows example measured vertical polar responses of the high frequency element in the coaxial driver, under an embodiment.

FIG. 10 illustrates measured vertical polar responses of the combined column of 5″ drivers with both elements of the coaxial driver and a crossover frequency of approximately 2 kHz, under an embodiment.

FIG. 11A illustrates a column loudspeaker with a coaxial center driver to provide narrow dispersion and an asymmetric horn high frequency driver, under a first alternative embodiment.

FIG. 11B illustrates a column loudspeaker with a coaxial center driver to provide narrow dispersion and an asymmetric horn high frequency driver, under a second alternative embodiment.

FIG. 12A illustrates a column loudspeaker with a horn as the center driver to provide controlled high frequency dispersion, under an embodiment.

FIG. 12B illustrates a column loudspeaker 1200 with a horn 1202 as the center driver to provide controlled high frequency dispersion, under an alternative embodiment.

FIG. 13 shows simulated vertical polar responses, at various frequencies, for an example eight 5″ diameter low frequency drivers and without a center driver.

FIG. 14A shows a column loudspeaker with a horn center speaker and low frequency drivers in the horn sidewalls, under an embodiment.

FIG. 14B shows a column loudspeaker with a horn center speaker and drivers that radiate through narrow slots in the horn sidewalls.

### DETAILED DESCRIPTION

Embodiments are described for a loudspeaker design that achieves narrow sound dispersion in one axis. Aspects of the one or more embodiments described herein may be implemented in a multi-driver loudspeaker system with drivers arranged in a vertical manner, though embodiments are not so limited. Any of the described embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

For purposes of description, the terms “sound dispersion” (also “dispersion” or “directivity”) describe the directional way sound from a source, in this case a loudspeaker, is dispersed or projected. Wide dispersion, or low directivity, indicates that a source radiates sound widely and fairly consistently in many directions, the widest being omnidirectional where sound radiates in all directions. Narrow dispersion, or high directivity, indicates that a source radiates sound more in one direction and predominantly over a limited angle. Dispersion and directivity can be different in different axes, for example vertical and horizontal, and can be different at different frequencies.

The term “loudspeaker” or “speaker” means a complete loudspeaker cabinet incorporating one or more loudspeaker drivers. A “driver” means a transducer that converts electrical energy into sound or acoustic energy, and may include a single electroacoustic transducer (or tight array of transducers) that produces sound in response to an electrical audio input signal. A driver may be implemented in any appropriate type, geometry and size, and may include horns, cones, ribbon transducers, and the like. Drivers may be categorized in terms of type for various frequency handling characteristics based on size and/or composition, such as tweeter, mid-range, woofer, sub-woofer, etc. For a speaker, the terms “enclosure,” “cabinet” or “housing” mean the unitary enclosure that encloses one or more drivers.

Embodiments are directed to a loudspeaker or loudspeaker systems in which certain types and configurations of individual drivers are used to impart certain narrow dispersion characteristics to the loudspeaker. Different types of drivers can be used to modify the dispersion effects of loudspeakers. For example, horns are frequently used to both improve the efficiency and control the dispersion pattern, or directivity, of a loudspeaker driver. They are mostly used with high frequency drivers, in particular compression drivers. In general, horns to control low frequency directivity are impractically large; however they are still used to improve efficiency. If appropriately designed, a horn has a fairly constant dispersion characteristic or directivity throughout its operating frequency range.

A coaxial loudspeaker driver consists of two or more moving driver elements, typically covering different frequency ranges and that are co-located such that their sound emanates from approximately the same point in space. One example is a driver consisting of a cone and, either in place of the dust cap or under the dust cap, a horn attached to a high frequency compression driver. The voice-coil attached to the cone and the voice-coil of the compression driver can share the same magnetic field, or each has their own magnets. In the latter case, either the compression driver and its horn sit in front of the cone, or the compression driver is mounted behind the magnet of the cone and the high frequency sound is tunneled through the center of the cone and magnet to the horn.

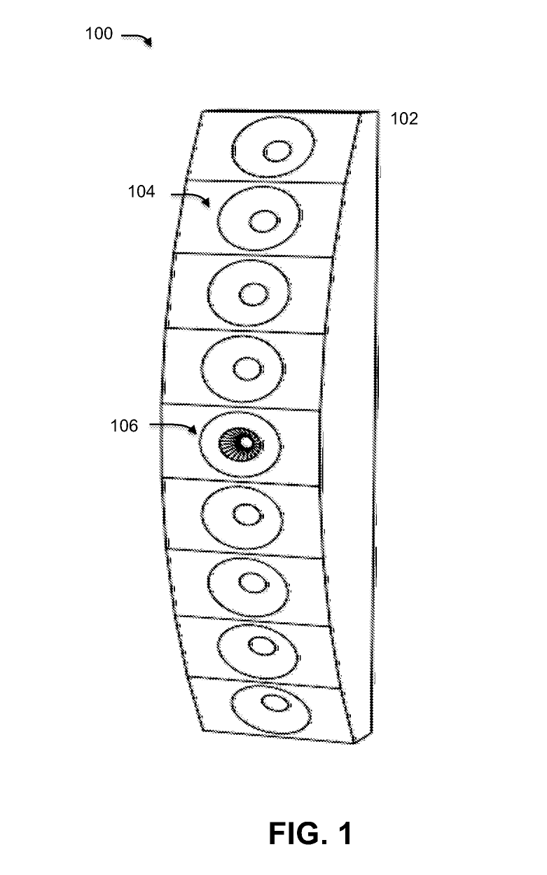

FIG. 1 illustrates a column (or “line array”) loudspeaker with a coaxial center driver to provide narrow dispersion, under some embodiments. Loudspeaker 100 comprises a cabinet 102 housing a number of individual drivers. Loudspeaker drivers 104 sufficient for producing lower frequencies are arranged in a line or column. The center driver 106 is a coaxial driver whose low frequency element or cone has characteristics that approximately match the characteristics of the other low frequency drivers in the column. These characteristics include maximum sound pressure level and frequency response shape. The low frequency drivers are delayed and gain adjusted such that the line exhibits constant directivity in the axis of the line. The high frequency element of the coaxial driver is selected such that it has approximately the same directivity, in the axis of the line, as the line of low frequency drivers.

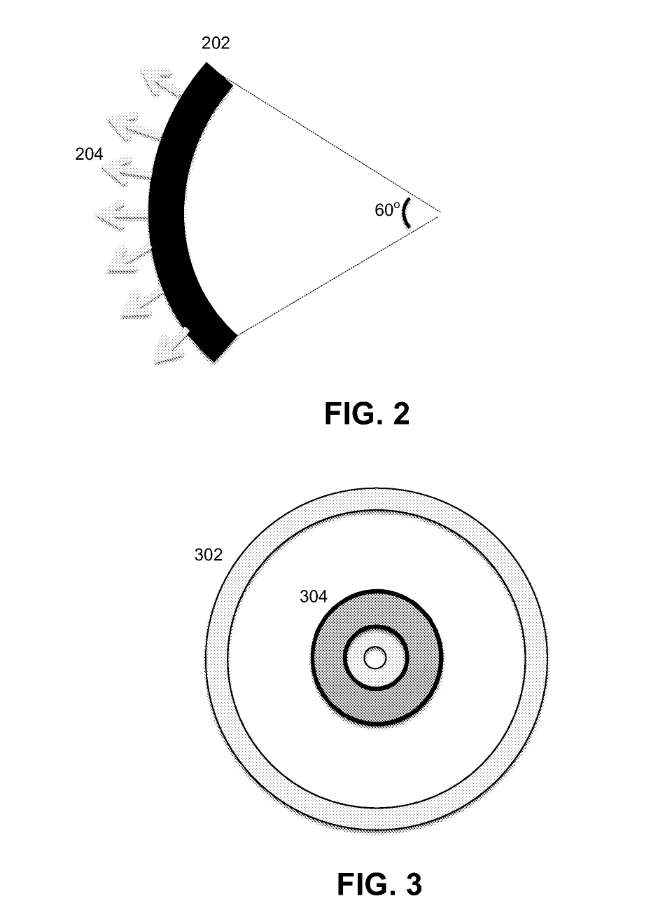

In general, drivers arranged in a flat line array speaker do not create a consistent sound field due to interference among the sound waves projected out of the flat surface. One solution to this problem is to introduce a time delay for the signals sent to at least some of the drivers. This can be done using either electrical circuitry or through physical placement of the drivers relative to one another. For the embodiment of FIG. 1, the cabinet 102 housing the loudspeaker drivers 104 and 106 is curved along an arc. In an embodiment, the curvature of the front of the cabinet is an arc of approximately 60 degrees, though other angles are also possible depending on application requirements and configuration constraints. This degree of arc provides the required acoustic delay to the drivers further back from the center coaxial driver 106 and introduces sufficient time delay to those drivers to create a relatively consistent sound field. FIG. 2 illustrates a curved speaker cabinet at a prescribed arc angle and housing a line array of drivers under an embodiment. As shown in FIG. 2, cabinet 202 is curved along an arc of 60 degrees so that the sound projections 204 for the individual drivers are directed outward at different angles from the front face of the cabinet.

Although FIG. 1 illustrates drivers arranged in a line vertically, it should be noted that the drivers may be aligned in any practical direction, including horizontally, or along any other linear arrangement or direction.

As stated above, in an embodiment, loudspeaker 100 includes a coaxial driver 106 placed as the center driver in a linear array of one-way drivers 104. FIG. 3 illustrates a coaxial driver that may be used in the loudspeaker of FIG. 1, under an embodiment. The coaxial driver of FIG. 3 is a 2-way speaker in which a tweeter or mid to high-frequency range driver 304 is placed in the front of the center portion of a larger lower-frequency range driver 302. The lower-frequency range driver 302 is generally a cone speaker type of driver, while the higher frequency driver 304 may be a cone speaker type of driver as well, or any other appropriate type of transducer, such as a horn or ribbon transducer. The frequency ranges of the low-frequency driver 302 and the high-frequency driver 304 may be configured to be of any appropriate respective frequency range. For example, the driver 302 may comprise a five-inch (5″) diameter loudspeaker driver with a useful frequency range of 70 Hz to 2 kHz, while the driver 304 may have a useful frequency range of 2 kHz to 18 kHz. Other frequency ranges are possible depending on driver types and configurations.

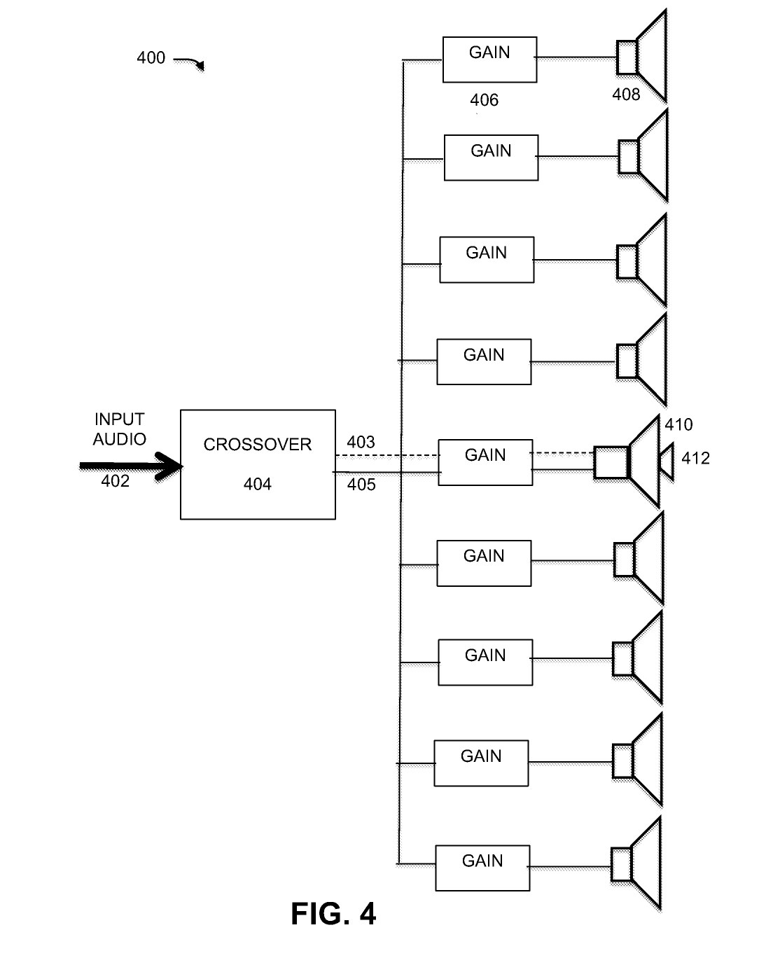

In an embodiment, each driver of the speaker is driven by a separate gain stage where the amount of gain depends on the position of the respective driver in the array. In addition, a crossover circuit is used to separate the audio signal into high and low frequency signals, and the low frequency signal is fed to the low frequency drivers and the low frequency element of the coaxial driver, while the high frequency signal is fed to the high frequency element in the coaxial driver. FIG. 4 is a schematic diagram of the speaker system of FIG. 1, under an embodiment. As shown in diagram 400 of FIG. 4, an input audio signal 402 is input to crossover circuit 404. This is a two-way crossover circuit that splits the input audio signal into a high frequency component 403 and a low-frequency component 405. The low frequency audio signal is sent to each of the drivers 408 through each drivers associated gain stage 406, and to the low frequency driver 410 of the center driver. The high-frequency audio signal is sent to the high frequency driver 412 of the center driver.

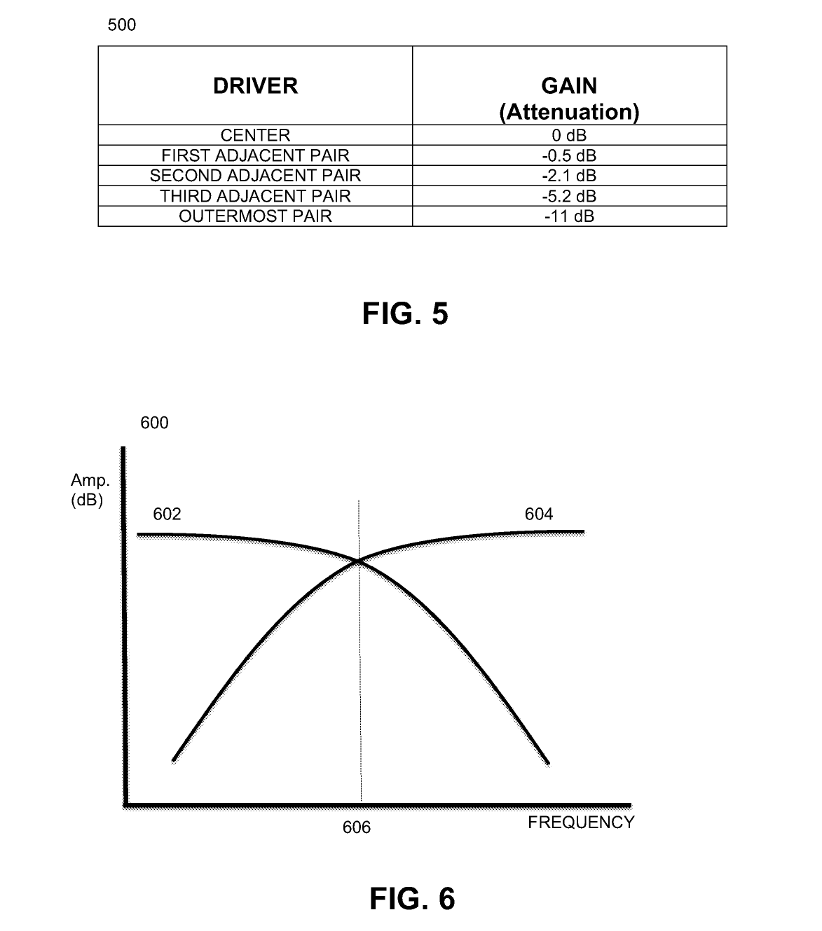

In an example implementation, the speakers 408 may comprise eight 5″ diameter loudspeaker drivers, with a useful frequency range of 70 Hz to 2 kHz, that are arranged in a cabinet approximate 1.2 meters tall, and both above and below a coaxial 5″ loudspeaker 410 with similar low frequency characteristics to the other speakers 408. The audio signal feeding the eight 5″ drivers and the low frequency element of the coaxial driver is gain adjusted separately for each driver resulting in maximum sound output from the center driver and progressively less sound output from drivers further away from the center driver. FIG. 5 is a table that lists example gain values for speakers in an array, under an embodiment. The values of table 500 are intended to be example values only and any other appropriate gain (or attenuation) values may be provided depending on speaker configuration and application requirements. Furthermore, the gain values are shown to be symmetrical in that matching pairs of non-center drivers have the same gain factor. That is, the first two drivers directly adjacent the center driver have the same gain factor as each other, the second two drivers directly adjacent the first two drivers have the same gain factor as each other, and so on. Alternatively, different gain values can be used for pairs of equidistant drivers.

The crossover circuit 404 may be implemented as a digital filter or electrical filter and is configured to separate the audio signal into high and low frequency signals at a specific and programmable crossover frequency. As shown in FIG. 4, the low frequency signal is fed to the low frequency drivers and the low frequency element of the coaxial driver, and the high frequency signal is fed to the high frequency element in the coaxial driver. FIG. 6 is a frequency response curve of a crossover that may be used in the speaker circuit of FIG. 4, under an embodiment. As shown in diagram 600 the crossover circuit generates a low-pass response 602 that passes frequencies in a low frequency range, such as from 70 Hz to 2 kHz, and a high pass response 604 that passes frequencies in a high frequency range, such as from 2 kHz to 18 kHz. The crossover frequency 606 corresponds to the frequency in which the curves drop below a defined threshold (e.g., −3 dB) from the maximum amplitude. These two frequency ranges are output separately from the crossover circuit so they can be routed to appropriate drivers in the speaker, such as to the low-frequency drivers and the high frequency driver in the center coaxial driver. In an embodiment, the crossover frequency is selected to be in the frequency range where the directivity of the high and low drivers match or overlap in the axis of the column. Thus, as shown in FIG. 6, the crossover frequency 606 may be 2 kHz for the example frequency ranges given above for the example coaxial driver.

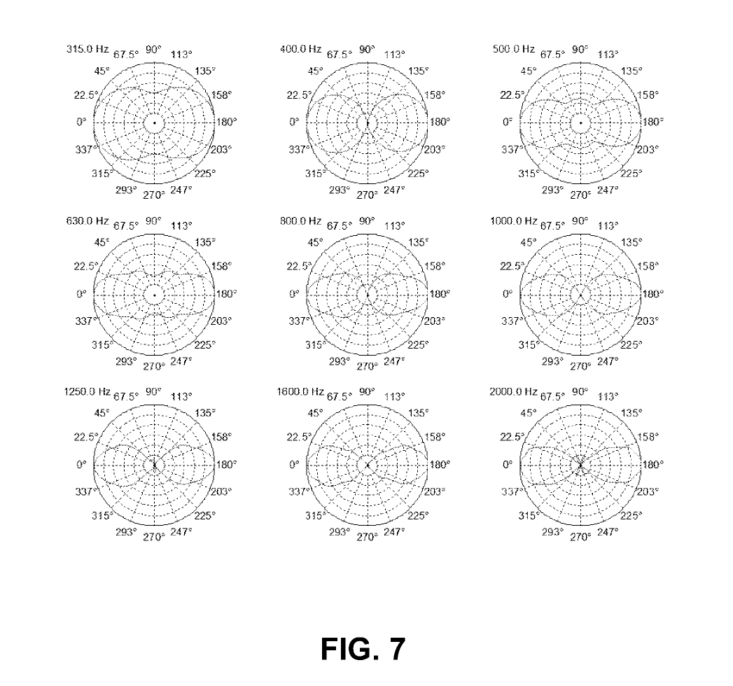

FIG. 7 illustrates simulated vertical polar responses at various frequencies for example loudspeakers drivers with a coaxial driver, under an embodiment. The example of

FIG. 7 may represent simulated plots for eight 5″ diameter loudspeaker drivers with a 5″ diameter coaxial loudspeaker as shown in FIG. 1, and at a distance of 20 meters. Zero (0) degrees, to the left of the plots, is the on-axis front or forward direction of the loudspeaker. Plots are provided for nine different frequencies ranging from 315 Hz to 2 kHz with 5 dB per division. As shown in FIG. 7, the simulation has significant symmetry, front-to-back, since each loudspeaker is modeled as a point source radiating in all directions. In practice, less energy will be project to the rear, or right in the plots. The simulation shows fairly constant directivity from approximately 500 Hz to 2 kHz with the main lobe approximately 40 degrees wide (−6 dB points) and almost no side-lobes.

In this example, the high frequency element in the chosen coaxial driver has approximately a 40-degree conical dispersion width through most of its frequency range of 1.5 kHz to 18 kHz. The crossover frequency is selected to be approximately 2 kHz. The crossover filters are implemented using third order filters and designed such that the high and low acoustic signals have approximately the same acoustic phase, in the forward direction, for approximately an octave around the crossover frequency.

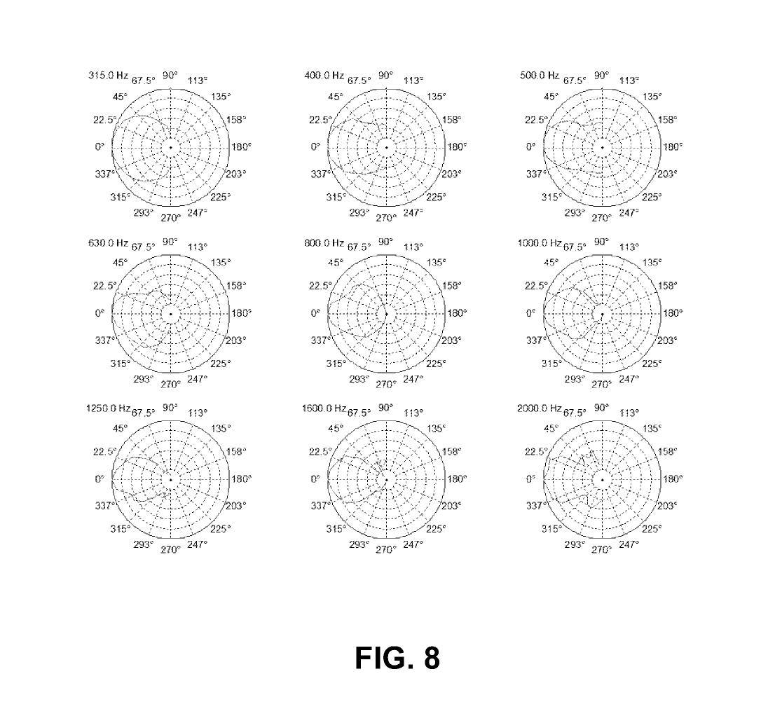

FIG. 8 shows measured vertical polar responses for the example loudspeaker at the same frequencies as in FIG. 7 and measured at a distance of approximately 4.3 meters. The measured responses are relatively similar to the simulated responses in FIG. 7 but have some slight differences and asymmetry which can be explained by manufacturing differences in the drivers and measurement inaccuracy.

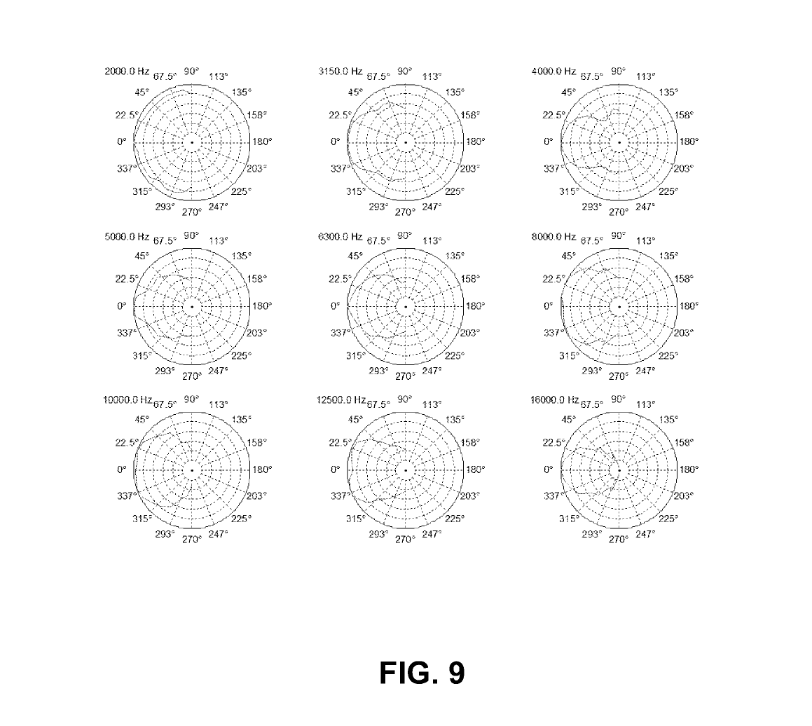

FIG. 9 shows example measured vertical polar responses of the high frequency element in the coaxial driver, under an embodiment. As shown in FIG. 9, at 2 kHz, its dispersion is wider than the dispersion of the low frequency loudspeaker drivers shown in FIG. 7 and FIG. 8.

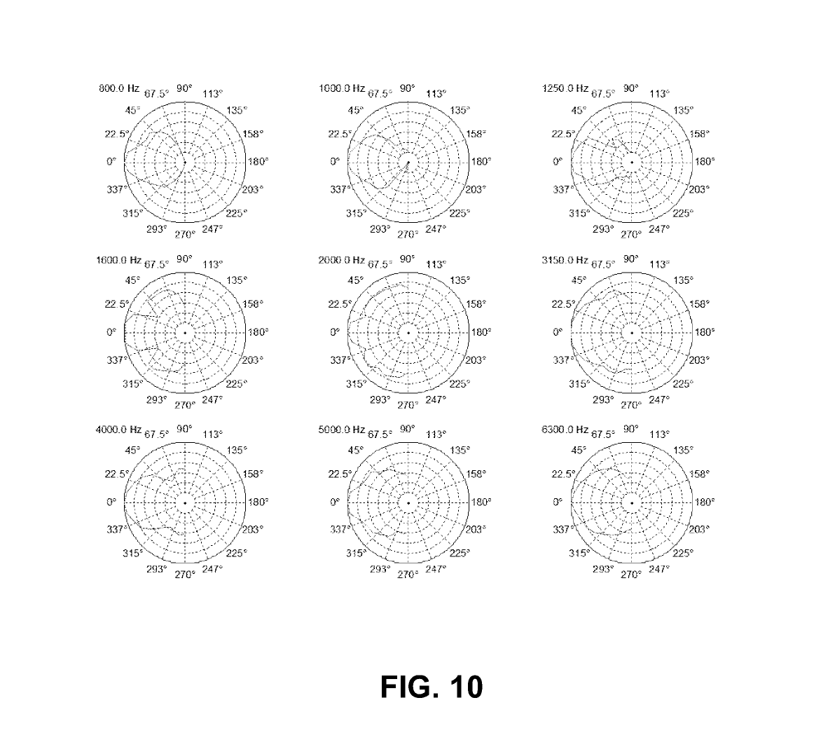

FIG. 10 illustrates measured vertical polar responses of the combined column of 5″ drivers with both elements of the coaxial driver and a crossover frequency of approximately 2 kHz, under an embodiment. FIG. 10 shows the vertical polar response of the combined loudspeaker with all drivers and elements radiating sound at the same time. For frequencies below the crossover frequency—800, 1000 and 1250 Hz—the responses are almost identical to the low frequency driver only measurements in FIG. 8. At 3150 Hz and above, the responses are identical to the high frequency only measurements in FIG. 9. Near the 2000 Hz crossover frequency, the vertical dispersion gets a little wider and has some lobing effects. This is due to the wider dispersion of the high frequency driver element at this frequency. The overly wide dispersion of the high frequency element in the coaxial driver can be reduced by using a larger horn in the coaxial loudspeaker driver.

As shown by the plots of FIGS. 7 to 10, the loudspeaker of FIG. 1 exhibits fairly consistent vertical directivity through a wide frequency range. The loudspeaker also has very wide horizontal dispersion below the crossover frequency, but narrower horizontal dispersion above the crossover frequency.

At high frequencies, the horizontal dispersion can be widened, to better match the wide dispersion of the low frequency line of drivers, by using a coaxial driver with an asymmetric horn. That is, a horn that has different horizontal and vertical dispersion characteristics. In an alternative embodiment, the coaxial driver of the loudspeaker comprises an asymmetric horn as the high-frequency driver.

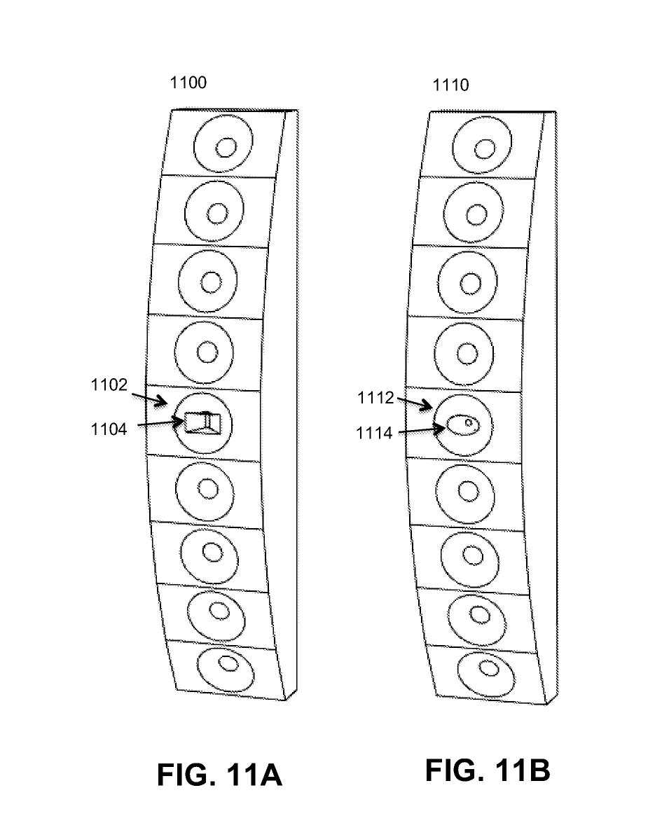

FIG. 11A illustrates a column loudspeaker with a coaxial center driver to provide narrow dispersion and an asymmetric horn high frequency driver, under a first alternative embodiment. In speaker 1100 the center driver 1102 features an asymmetric horn 1104 with a rectangular shaped chamber. FIG. 11B illustrates a column loudspeaker with a coaxial center driver to provide narrow dispersion and an asymmetric horn high frequency driver, under a second alternative embodiment. In FIG. 11B, speaker 1110 features a center driver 1112 that has an asymmetric horn 1114 with a circular or oblong shaped chamber.

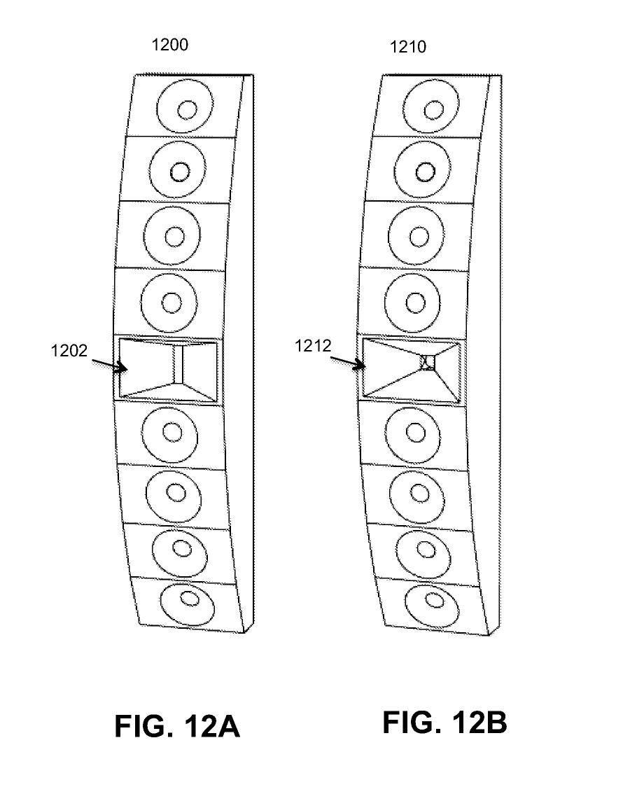

For more control of the high frequency dispersion characteristics in both horizontal and vertical axes, a horn could be used in place of the coaxial driver. Some examples are shown in FIGS. 12A and 12B. FIG. 12A illustrates a column loudspeaker 1200 with a horn 1202 as the center driver to provide controlled high frequency dispersion, under an embodiment. FIG. 12B illustrates a column loudspeaker 1210 with a horn 1212 as the center driver to provide controlled high frequency dispersion, under an alternative embodiment, and in which the horn is of a different configuration to that of speaker 1200. In either case, the height of the horn need not be similar to the diameter of the adjacent low frequency drivers, but rather just high enough to give the desired vertical high frequency directivity over the frequency range of its use.

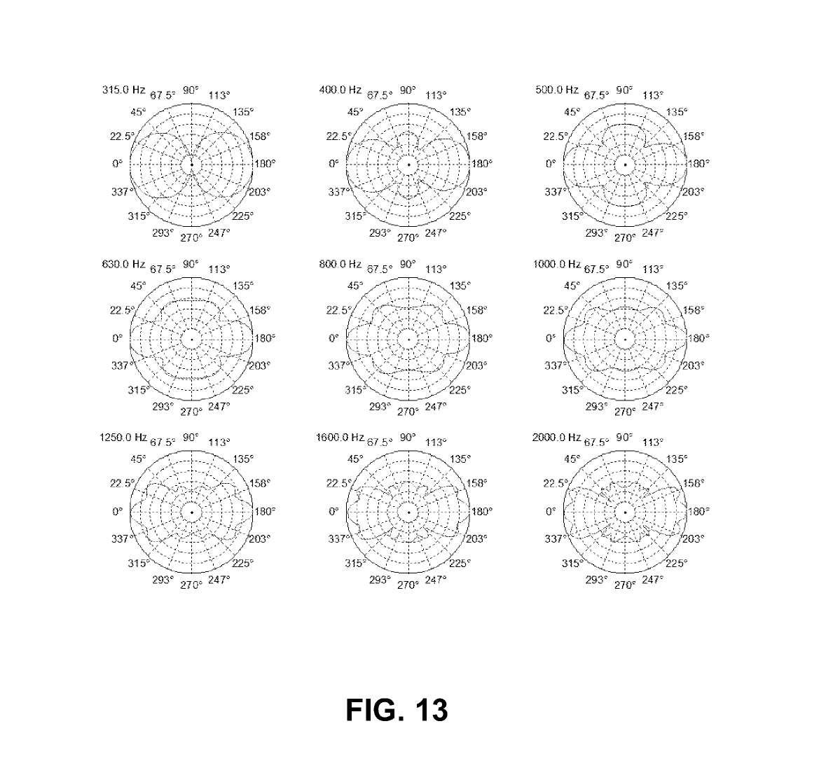

The use of the horn in place of the coaxial loudspeaker driver, as shown in FIGS. 12A and 12B, and the resulting absence of low frequency sound emanating from the center of the line, does change the vertical dispersion pattern of the low frequency drivers. FIG. 13 shows simulated vertical polar responses, at various frequencies, for an example eight 5″ diameter low frequency drivers and without a center driver. As can be seen in FIG. 13, there is an increase in side-lobes and the patterns are not as smooth, but the overall energy is still predominantly directed forward of the loudspeaker.

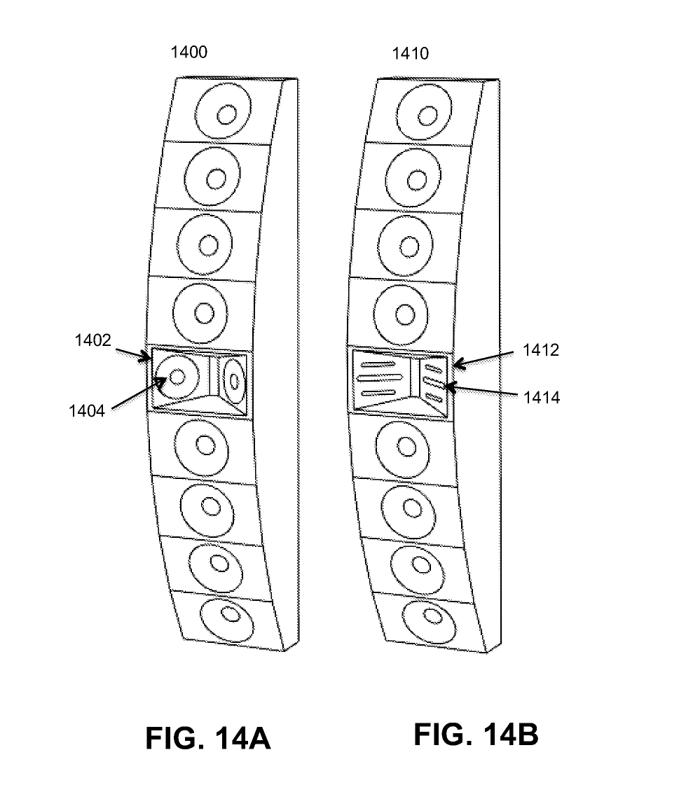

To fix the aberrations in the vertical polar response due to the use of a horn in the center, one or more low frequency drivers could be positioned in the side walls of the horn such that they radiate low frequency sound out through the horn. Such an approach is illustrated in FIGS. 14A and 14B. FIG. 14A shows a column loudspeaker 1400 with horn center speaker 1402 and low frequency drivers 1404 in the horn sidewalls, under an embodiment. As shown in FIG. 14A, the low-frequency drivers 1404 are mounted directly in the side walls of the horn. FIG. 14B shows a column loudspeaker 1410 with horn center speaker 1412 and drivers that radiate through narrow slots 1414 in the horn sidewalls. In this configuration, more side wall surface area is retained for directing the high frequency energy from the high frequency driver.

Embodiments have been described for a column loudspeaker with a line of low-frequency drivers arranged around a center coaxial driver with a low frequency driver and a high frequency driver. The low frequency drivers are delayed and gain adjusted such that they exhibit constant directivity in the axis of the line and the high frequency driver has the same directivity as the line of low frequency drivers. A crossover separates the audio signal into high and low frequency signals with low frequency signals sent to the low frequency drivers, and high frequency signals sent to the high frequency element in the coaxial driver. The crossover frequency is in the frequency range where the directivity of the high and low frequency drivers match. The loudspeaker cabinet is curved to provide an acoustic delay to the drivers further away from the center coaxial driver.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A loudspeaker comprising:
a plurality of drivers arranged in a linear arrangement along a first axis;
a center coaxial driver disposed in a center position of the linear arrangement and having a low frequency driver and a high frequency driver;
a gain stage associated with each driver of the plurality of drivers and the center driver; and
a crossover configured to transmit low-frequency audio to the plurality of drivers and the low-frequency driver of the center coaxial driver and to transmit high frequency audio to the high-frequency driver of the center coaxial driver.

2. The loudspeaker of claim 1 further comprising a speaker cabinet enclosing the plurality of drivers and the center driver.

3. The loudspeaker of claim 2 wherein the cabinet is configured to have a curvature prescribing an arc of approximately 60 degrees to provide an acoustic delay relative to the center coaxial driver to drivers disposed closer to the end of the linear arrangement.

4. The loudspeaker of claim 1 wherein the low frequency driver of the center coaxial driver is configured to have matching characteristics to the plurality of drivers.

5. The loudspeaker of claim 4 wherein the matching characteristics comprise maximum sound pressure level and frequency response shape.

6. The loudspeaker of any of claims 1 to 5 wherein the plurality of drivers are delayed and gain adjusted such that the linear arrangement of drivers exhibits constant directivity along the first axis.

7. The loudspeaker of claim 6 wherein the low-frequency driver of the center coaxial driver passes audio signals in a first frequency range, and the high-frequency driver of the center coaxial driver passes audio signals in a second, higher frequency range, and wherein the first and second frequency ranges are defined by a crossover frequency.

8. The loudspeaker of claim 7 wherein the crossover frequency is selected to match the frequency range where the directivity of the high frequency driver and low frequency driver overlap.

9. The loudspeaker of any of claims 1 to 8 wherein the high frequency driver of the center coaxial speaker comprises a symmetrical horn transducer.

10. The loudspeaker of any of claims 1 to 8 wherein the high frequency driver of the center coaxial speaker comprises an asymmetrical horn transducer.

11. The loudspeaker of any of claims 1 to 8 wherein the high frequency driver of the center coaxial speaker comprises a cone transducer.

12. The loudspeaker of any of claims 1 to 8 wherein the center coaxial speaker itself comprises a horn transducer.

13. The loudspeaker of claim 12 further comprising one or more cone drivers disposed in one or more walls of the horn transducer.

14. The loudspeaker of claim 13 wherein the one or more walls include a plurality of slots, and wherein the one or more cone drivers is configured to radiate sound through the plurality of slots.

15. The loudspeaker of claim 7 wherein the low frequency drivers comprise five-inch cone drivers and the first frequency range comprises 70 Hz to 3 kHz, and wherein the second frequency range comprises an audible frequency range above 3 kHz.

16. A column loudspeaker comprising:
a line of low frequency drivers arranged around a center coaxial driver having a low frequency driver and a high frequency driver, wherein the low frequency drivers are delayed and gain adjusted to thereby exhibit constant directivity along the line, and wherein the high frequency driver has the same directivity as the line of low frequency drivers;
a crossover configured to separate an input audio signal into high and low frequency signals, wherein the low frequency signals are sent to the low frequency drivers, and high frequency signals sent to the high frequency driver; and
a curved loudspeaker cabinet enclosing the low frequency drivers and the center coaxial driver.

17. The loudspeaker of claim 16 wherein the cabinet is configured to have a curvature prescribing an arc of approximately 60 degrees to provide a proportionate acoustic delay relative to the center coaxial driver to drivers disposed increasingly further away from the center coaxial driver.

18. The loudspeaker of claim 17 wherein the low frequency driver of the center coaxial driver is configured to have matching characteristics to the line of low frequency drivers, and wherein the matching characteristics comprise maximum sound pressure level and frequency response shape.

19. The loudspeaker of any of claims 16 to 18 wherein the low-frequency driver of the center coaxial driver passes audio signals in a first frequency range, and the high-frequency driver of the center coaxial driver passes audio signals in a second, higher frequency range, and wherein the first and second frequency ranges are defined by a crossover frequency.

20. The loudspeaker of claim 19 wherein the crossover frequency is selected to match the frequency range where the directivity of the high frequency driver and low frequency driver overlap.

21. The loudspeaker of any of claims 16 to 20 wherein the high frequency driver of the center coaxial speaker comprises one of: a symmetrical horn transducer and an asymmetrical horn transducer.

22. The loudspeaker of any of claims 16 to 20 wherein the center coaxial speaker itself comprises a horn transducer.

23. The loudspeaker of claim 22 further comprising one or more cone drivers disposed in one or more walls of the horn transducer.

24. The loudspeaker of claim 23 wherein the one or more walls include a plurality of slots, and wherein the one or more cone drivers is configured to radiate sound through the plurality of slots.

25. The loudspeaker of claim 19 wherein the low frequency drivers comprise five-inch cone drivers and the first frequency range comprises 70 Hz to 2 kHz, and wherein the second frequency range comprises an audible frequency range above 2 kHz.
